(19) United States
(12) Patent Application Publication
(10) Pub. No.: US 2026/0097959 A1
(43) Pub. Date: Apr. 9, 2026

(54) METHOD OF MAKING EXPANDED HEXAGONAL BORON NITRIDE

(71) Applicant: Drexel University, Philadelphia, PA (US)

(72) Inventor: Megan A. Creighton, Wallingford, PA (US)

(73) Assignee: Drexel University, Philadelphia, PA (US)

(21) Appl. No.: 19/333,323

(22) Filed: Sep. 18, 2025

Related U.S. Application Data
(60) Provisional application No. 63/696,883, filed on Sep. 20, 2024.

(51) Int. Cl. C01B 21/064; C09K 5/14

(52) U.S. Cl. CPC C01B 21/0648; C09K 5/14; C01P 2002/72; C01P 2002/76; C01P 2004/03; C01P 2004/20; C01P 2004/61; C01P 2006/32

(57) ABSTRACT

Methods of making expanded hexagonal boron nitride including steps of: a) intercalating a hexagonal boron nitride with one or more guest molecules to form an intercalated hexagonal boron nitride; and b) thermally shocking the intercalated hexagonal boron nitride to form the expanded hexagonal boron nitride. An expanded hexagonal boron nitride formed by the method.

### CROSS REFERENCE TO RELATED APPLICATIONS

This application claims the benefit of U.S. Provisional Application No. 63/696,883, filed on Sep. 20, 2024, the entire disclosure of which is hereby incorporated by reference as if set forth fully herein.

### BACKGROUND OF THE INVENTION

As electronic devices and components become thinner, lighter, and more powerful, thermal management is becoming increasingly more critical to prolong component life, reduce operating temperature, and mitigate hotspots. In many cases passive methods are preferred since moving parts, such as fans, have large space requirements, consume energy, and create vibrations that can disturb other system processes.

Flexible graphite is one widespread commercial solution for thermal management needs. Graphite has a layered crystal structure, from which stems highly anisotropic thermal properties. The in-plane thermal conductivity, depending on material quality, is on the order of 400 W/mK, whereas the out-of-plane thermal conductivity is an order of magnitude lower. Flexible graphite is able to take advantage of this material property and offer head spreading, using high in-plane thermal conduction, for passive cooling and hot spot mitigation while simultaneously also offering heat shielding, using low out-of-plane thermal conduction, from other neighboring components.

Flexible graphite is made from expandable graphite (FIG. 1). Certain molecules, known as “guest molecules” can intercalate within the layers of the graphite crystal structure. Examples include many concentrated acids, such as sulfur acid or nitric acid. When the intercalated material is subject to a rapid increase in temperature (often referred to as a “thermal shock”), the guest molecules undergo a phase transformation, which leads to increased pressure inside the lamellar structure, and can cause rapid expansion to form expanded graphite or sometimes what is known as “vermiform graphite”. Large lateral dimensions of the graphite are favorable for attaining larger expansion volumes, because of the smaller ratio of perimeter (which determines the rate that guest molecules can escape) to internal volume (which determines the total amount of guest molecules present). Expandable graphite is sold commercially and commonly used in firestop applications.

To make flexible graphite, the expanded graphite is calendared or molded into sheet form. The edges of the expanded graphite are rough, and the final article is held together by a mechanical interlock, without the use of additional additives or binders. This is advantageous, as such additives and binders generally detract from the desired thermal properties.

There is a need to find another material suitable for providing improved thermal conductivity and improved stability.

### SUMMARY OF THE INVENTION

The present invention may be described by the following sentences:
1. In a first aspect, the present invention relates to a method for making expanded hexagonal boron nitride comprising steps of:
intercalating hexagonal boron nitride with one or more guest molecules to form an intercalated hexagonal boron nitride; and
thermally shocking the intercalated hexagonal boron nitride to form expanded hexagonal boron nitride.
2. The method of sentence 1, wherein the one or more guest molecules are strong acids.
3. The method of any one of sentences 1-2, wherein the strong acid is selected from the group consisting of sulfuric acid, phosphoric acid, perchloric acid, chloric acid, hydrobromic acid, hydrochloric acid, hydroiodic acid, acetic acid, formic acid, benzenesulfonic acid, and water.
4. The method of any one of sentences 1-3, wherein the step of thermally shocking the intercalated hexagonal boron nitride is carried out at a temperature of from about 300° C. to about 1000° C.
5. The method of any one of sentences 1-4, wherein the hexagonal boron nitride has an average particle size of from about 1 micron to about 50 microns.
6. The method of any one of sentences 1-5, wherein the hexagonal boron nitride is intercalated with the one or more guest molecules in a mass ratio of 0.1 to 100 grams of one or more guest molecules per gram of hexagonal boron nitride, or from about 3 to 26 grams of the one or more guest molecules per gram of hexagonal boron nitride.
7. The method of any one of sentences 1-6, wherein the step of thermally shocking the intercalated hexagonal boron nitride is carried out at a temperature of from about 500° C. to about 1000° C.
8. The method of any one of sentences 1-7, wherein the step of thermally shocking the intercalated hexagonal boron nitride is carried out at a heating rate of 10° C./minute or greater.
9. The method of any one of sentences 1-8, wherein the step of thermally shocking the intercalated hexagonal boron nitride is carried out at a heating rate of 15° C./minute or greater.
10. The method of any one of sentences 1-9, wherein the step of thermally shocking the intercalated hexagonal boron nitride is carried out at a heating rate of 50° C./minute or greater.
11. In a second aspect, the present invention relates to an expanded hexagonal boron nitride formed by the method of any one of sentences 1-11.
12. The expanded hexagonal boron nitride of sentence 11, having an in-plane thermal conductivity of greater than 400 W/mK.
13. The expanded hexagonal boron nitride of any one of sentences 11-12, having an out-of-plane thermal conductivity of less than 100 W/mK.
14. The expanded hexagonal boron nitride of any one of sentences 11-13, wherein the expanded hexagonal boron nitride is in the form of a sheet having a thickness of from about 1 micron to 100,000 microns, or from about 100 microns to 15,000 microns.
15. The expanded hexagonal boron nitride of any one of sentences 11-14, wherein the expanded hexagonal boron nitride is formed using a strong acid is selected from the group consisting of sulfuric acid, phosphoric acid, perchloric acid, chloric acid, hydrobromic acid, hydrochloric acid, hydroiodic acid, acetic acid, formic acid, benzenesulfonic acid, and water.

Additional details and advantages of the disclosure will be set forth in part in the description which follows, and/or may be learned by practice of the disclosure. The details and advantages of the disclosure may be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

FIG. 1A shows a schematic of the intercalation of graphite and the expansion resulting from thermal shock.

FIGS. 1B-1E show four images, FIG. 1B is a micrograph image showing a graphite flake.

FIG. 1C is a macroscale image showing graphite flakes intercalated with guest compounds.

FIG. 1D is a micrograph showing an expanded vermiform graphite after exposure to thermal shock.

FIG. 1E is a macroscale image showing the volume expansion after exposing intercalated graphite to a thermal shock.

FIG. 2 shows the structural similarities and differences between hexagonal boron nitride (hBN) and graphite. FIG. 2, image (a) shows the crystal structure of hBN which consists of layers of boron (light gray) and nitrogen (dark gray) atoms alternating in a hexagonal arrangement. FIG. 2, image (b) shows the crystal structure of graphite that consists of only carbon atoms arranged in a similar layered hexagonal arrangement.

FIG. 3 shows X-ray Diffraction (XRD) spectra for phosphoric acid and sulfuric acid samples which revealed an increased intensity with a peak at 24°, which is present in bulk h-BN but significantly more pronounced in the post-intercalation SP6 samples of the present invention.

FIG. 4 shows scanning electron microscopy (SEM) images of SP6 h-BN samples intercalated with phosphoric acid after a 900° C. thermal shock. The left image shows the conglomeration of flakes, while the right image provides a close-up view of crystalline boron phosphate (white) surrounding the h-BN.

FIG. 5 shows SEM images of the SP30 h-BN samples intercalated with phosphoric acid after a 900° C. thermal shock. The images reveal aggregation of flakes into clusters due to the formation of boron phosphate. Each image progressively increases in magnification going in a clockwise direction from the top left image. Higher magnification shows gaps and disorder in the cross-sections of the flakes.

FIG. 6 shows XRD analysis of the SP6 h-BN samples with phosphoric acid intercalation and after a 900° C. thermal shock. The intercalated phase shows a visible 001n peak, indicating successful intercalation. An increase in the peak at 24° is observed in both the intercalated state and the state after thermal shock. The spectrum after thermal shock also exhibited small peaks as bumps in the 14-23° range, which suggest expansion.

FIG. 7 shows SEM images of SP6 (left) and SP30 (right) h-BN intercalated with phosphoric acid after a 500° C. thermal shock. The white areas are believed to be boron phosphate.

FIG. 8 shows images of SP6 (left) and SP30 (right) h-BN before drying, showing the white coloring of the base h-BN material.

FIG. 9 shows images of SP6 (left) and SP30 (right) h-BN with nitric acid intercalation after drying. The white coloration of the base h-BN is retained, indicating no significant change.

FIG. 10 shows images of SP6 (left) and SP30 (right) h-BN with phosphoric acid intercalation after drying. The grayish coloring observed in both samples suggests intercalation.

FIG. 11 shows images of SP6 (left) and SP30 (right) h-BN with sulfuric acid intercalation after drying. The grayish coloring observed in both samples suggests intercalation.

FIG. 12 shows XRD analysis of SP6 h-BN after attempted intercalation with nitric acid, compared to SP6 bulk h-BN. No additional peaks are observed, particularly the 001n peak, with only a reduction in the intensity of some bulk peaks.

FIG. 13 shows XRD analysis of SP30 h-BN after attempted intercalation with nitric acid, compared to SP30 bulk h-BN. No additional peaks are observed, particularly the 001n peak, with only a reduction in the intensity of some bulk peaks.

FIG. 14 shows XRD analysis of SP6 h-BN with phosphoric acid intercalation and post-900° C. thermal shock. The intercalated phase shows a visible 001n peak, indicating successful intercalation. An increase in the peak at 24° is observed in both the intercalated state and after thermal shock. The thermal shock spectrum also exhibited small peaks as bumps in the 14-23° range, which suggest expansion.

FIG. 15 shows XRD analysis of SP30 h-BN with phosphoric acid intercalation and post-900° C. thermal shock. The intercalated phase shows a visible 001n peak, indicating successful intercalation. An increase in the peak at 24° is observed in both the intercalated state and after thermal shock, though not as pronounced as in the SP6 intercalations. The thermal shock spectrum also exhibited small peaks as bumps in the 14-23° range, which suggest expansion.

FIG. 16 shows XRD analysis of SP6 h-BN with sulfuric acid intercalation and post-900° C. thermal shock. The intercalated phase shows a visible 001n peak, indicating successful intercalation. However, after thermal shock, no additional peaks are observed, suggesting that expansion was unsuccessful.

FIG. 17 shows XRD analysis of SP6 h-BN with sulfuric acid intercalation and post-900° C. thermal shock. The absence of a substantial 001n peak suggests unsuccessful intercalation. After thermal shock, no additional peaks are observed compared to the bulk SP6 h-BN, indicating that expansion was unsuccessful.

FIG. 18 shows SEM images of bulk SP6 (left) and SP30 (right) h-BN. The cross-sections are largely smooth, with the bulk SP30 h-BN showing particularly smooth surfaces.

FIG. 19 shows SEM images of SP6 (left) and SP30 (right) h-BN intercalated with sulfuric acid after a 900° C. thermal shock. Minimal aggregation is observed, and no discernible changes are observed compared to bulk h-BN.

FIG. 20 shows SEM images of SP6 h-BN intercalated with phosphoric acid after a 900° C. thermal shock. The left image shows the conglomeration of flakes, while the right image provides a close-up view of crystalline boron phosphate (white) surrounding the h-BN.

FIG. 21 shows SEM images of SP30 h-BN intercalated with phosphoric acid after a 900° C. thermal shock. The images reveal aggregation of flakes into clusters due to boron phosphate formation. Higher magnification shows gaps and disorder in the cross-sections of the flakes.

FIG. 22 shows a close-up SEM image of SP30 with phosphoric acid after a 900° C. thermal shock. The image shows partial expansion of the flakes, suggesting thermal expansion. The rough cross-section may indicate increased interlayer spacing.

FIG. 23 shows SEM images of SP6 (left) and SP30 (right) h-BN intercalated with phosphoric acid after a 500° C. thermal shock. The white areas are believed to be boron phosphate.

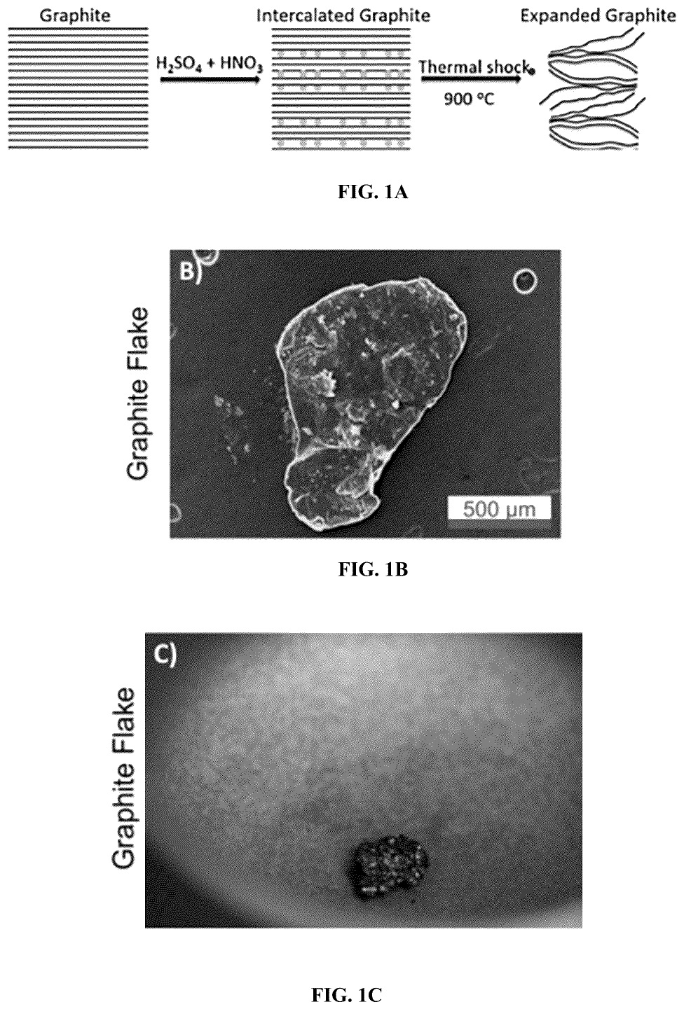

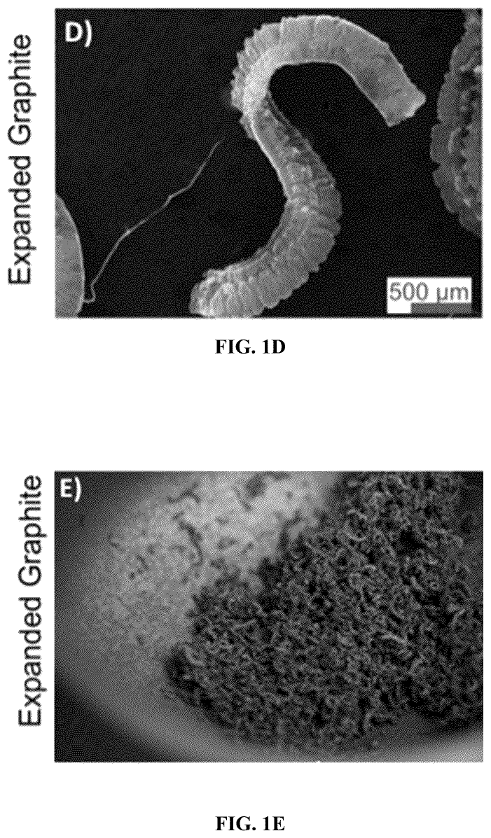

### DESCRIPTION OF THE INVENTION

Although illustrative embodiments of one or more aspects are provided herein, the disclosed processes may be implemented using any number of techniques. The disclosure is not limited to the illustrative or specific embodiments, any drawings, and any techniques illustrated herein, including any exemplary designs and embodiments illustrated and described herein, and may be modified within the scope of the appended claims along with their full scope of equivalents.

The present disclosure relates to a method for making expanded hexagonal boron nitride that provides improved thermal conductivity and improved stability compared to flexible graphite. Flexible graphite is a foil-like material composed entirely of graphitic particles and is commonly used for thermal management. The unique layered crystal structure of graphite imparts highly anisotropic thermal properties. Specifically, the in-plane thermal conductivity can reach around 400 W/mK, depending on material quality, while the out-of-plane thermal conductivity is significantly lower. These properties enable flexible graphite to effectively spread heat (due to high in-plane thermal conduction) for passive cooling and hot spot mitigation, while also providing heat shielding (due to low out-of-plane thermal conduction) to protect adjacent components.

The production of flexible graphite begins with one of the forms known as expanded graphite or vermiform graphite. During this process, certain molecules, called “guest molecules” (e.g., strong acids), intercalate between the layers of the crystal structure of the graphite. When subjected to a rapid temperature increase, or “thermal shock,” these guest molecules undergo a phase transformation that increases the pressure within the lamellar structure. This pressure can cause the graphite to expand rapidly into a worm-like form known as vermiform graphite¹. The large lateral dimensions of the graphite facilitate greater expansion volumes due to the favorable ratio of perimeter to internal volume, which affects the rate at which guest molecules escape.

To produce flexible graphite, the expanded vermiform graphite is calendared or molded into a sheet. The final product's structural integrity is the result of mechanical interlocking of the rough-edged vermiform graphite, without the need for additional additives or binders¹. This approach is beneficial because additives and binders can adversely impact the material's desirable thermal properties.

Flexible graphite, while widely used for thermal management, has limitations in its thermal conductivity and chemical stability, creating a need for alternative materials that can provide both heat spreading and heat shielding while remaining stable in various environments.

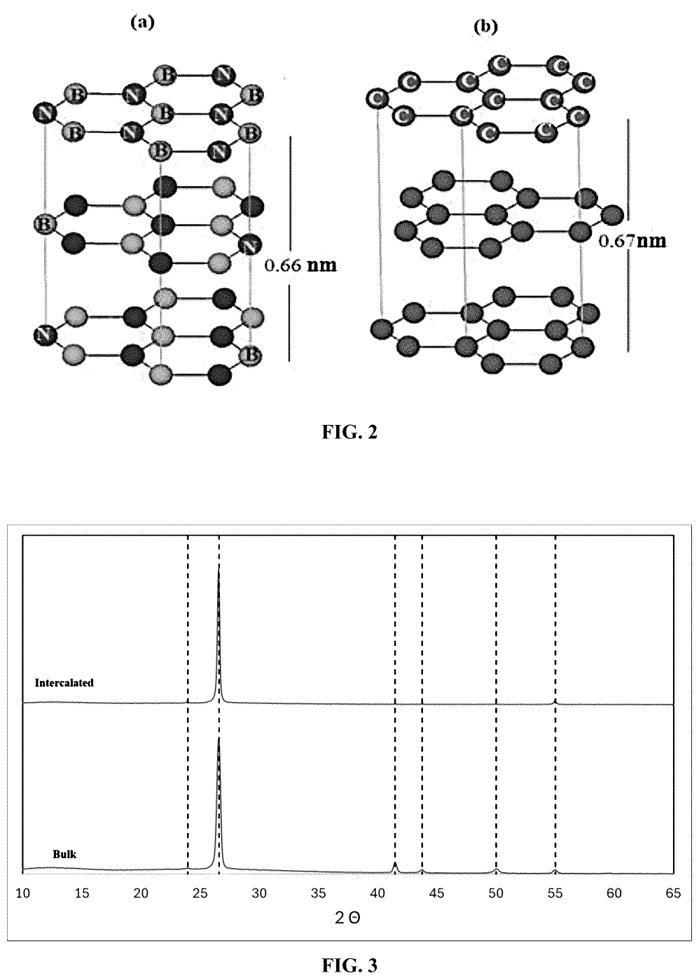

Both boron nitride and graphite have a crystal structure that is composed of layers of hexagonally arranged atoms. A key difference is that graphite is composed entirely of carbon atoms, whereas boron nitride is composed of alternating boron and nitrogen atoms (FIG. 2). As a result, boron nitride has higher in-plane thermal conductivity, approximately 600 W/mK, compared to the in-plane thermal conductivity of graphite, which is approximately 400 W/mK. Also, boron nitride exhibits similar anisotropic properties for out-of-plane conduction. It is electrically insulating and has superior chemical stability. Consequently, a binder-free h-BN film could be used in applications requiring effective heat sinks, especially in electronic devices

The present invention relates to the creation of an analogue of this flexible graphite using hBN. hBN can be intercalated with guest molecules such as strong acids, as detailed in the publication by Kovtyukhova et al.¹ The present invention provides a process of using the intercalated hBN to make expanded hBN. This expanded hBN may be further processed or calendared into a thin, flexible film suitable for commercial applications.

Although the expanded hexagonal boron nitride of the present invention does not achieve the same expansion volume as vermiform graphite, expanded hexagonal boron nitride is superior to vermiform graphite in several respects. For example, expanded boron nitride provides improved chemical and thermal stability, and improved thermal conductivity when compared to vermiform graphite. Accordingly, expanded hexagonal boron nitride provides superior performance over vermiform hexagonal graphite in applications such as fire retardants, electronics, and chemical barriers.

The present invention relates to a method of making expanded hexagonal boron nitride comprising steps of:
(i) intercalating hexagonal boron nitride with one or more guest molecules to form intercalated hexagonal boron nitride; and
(ii) thermally shocking the intercalated boron nitride to form expanded hexagonal boron nitride.

Exemplary guest molecules for use in the intercalation step are strong acids, suitable to provide effective intercalation between the layers of hexagonal boron nitride. The strong acid may be selected from sulfuric acid (H₂SO₄), phosphoric acid (H₃PO₄), perchloric acid (HClO₄), chloric acid (HClO₃), hydrobromic acid (HBr), hydrochloric acid (HCl), hydroiodic acid (HI), nitric acid (HNO₃), formic acid (HCOOH), and benzenesulfonic acid (C₆H₆O₃S). Alternatively, the guest molecules for use in the intercalation step may include weaker acids and water (H₂O), for example, a suitable weaker acid may be selected from acetic acid (CH₃COOH). Preferred guest molecules include, but are not limited to, sulfuric acid (H₂SO₄), phosphoric acid (H₃PO₄), and perchloric acid (HClO₄). In a preferred embodiment, sulfuric acid is used as the guest molecule due to its strong intercalating properties and ability to penetrate between the layers of hexagonal boron nitride effectively. The hexagonal boron nitride may be intercalated using methods such as the method taught by Kovtyukhova et al. “Reversible Intercalation of Hexagonal Boron Nitride with Brønsted Acids.” Journal of the American Chemical Society, 10 May 2013, 8372-8381. Any other suitable method known in the art may also be used to form the intercalated hexagonal boron nitride.

The thermal shock may be provided by exposing the intercalated boron nitride to a temperature of from about 300° C. to about 1000° C., or from about 500° C. to about 1000° C., or from about 900° C. to about 1000° C. The thermal shocking step may be carried out at a heating rate of greater than 10° C./minute, or greater than 15° C./minute, or greater than 50° C./minute. The step of thermally shocking the intercalated boron nitride must be carried out at a heating rate high enough to ensure that the intercalated hexagonal boron nitride will expand.

According to another aspect, the present invention relates to an expanded hexagonal boron nitride produced by the method which provides improved chemical and thermal stability compared to vermiform graphite. The expanded hexagonal boron nitride has higher in-plane thermal conductivity (approximately 600 W/mK) compared to vermiform graphite (approximately 400 W/mK), while exhibiting anisotropic thermal properties with low out-of-plane thermal conductivity (less than 100 W/mK or about 30 W/mK), allowing it to provide both heat spreading and heat shielding capabilities. The expanded hexagonal boron nitride formed by the present method may have an in-plane thermal conductivity of greater than 400 W/mK, or greater than 450 W/mK, or greater than 500 W/mK, or from about 450 w/mK to about 700 W/mK, or about 600 W/mK. The expanded hexagonal boron nitride may have an out-of-plane thermal conductivity of about less than 100 W/mK, or about 30 W/mK. Additionally, the expanded hexagonal boron nitride is electrically insulating, providing advantages over graphite in certain applications, and offers superior performance in applications such as fire retardants, electronics, and chemical barriers.

The process of intercalating hexagonal boron nitride involves mixing the hexagonal boron nitride powder with the selected strong acid in a suitable container, such as a glass beaker. The hexagonal boron nitride powder may have an average particle size of from about 1 micron to about 50 microns, or from about 1 micron to about 40 microns, or from about 5 microns to about 35 microns. The mixture is stirred thoroughly to ensure uniform distribution of the acid throughout the hexagonal boron nitride material. The intercalation process allows the guest molecules to insert themselves between the layers of the hexagonal boron nitride structure, expanding the interlayer spacing and weakening the interlayer forces.

After the intercalation process is complete, the intercalated hexagonal boron nitride is thermally shocked to form the expanded hexagonal boron nitride. The thermal shocking step is carried out at a temperature of from about 300° C. to about 1000° C. In a preferred embodiment, the thermal shocking is performed at a temperature of from about 500° C. to about 1000° C., which provides optimal conditions for the expansion and exfoliation of the intercalated hexagonal boron nitride.

The thermal shocking process is conducted at a heating rate of 10° C./minute or greater to ensure rapid expansion of the intercalated material. In a preferred embodiment, the heating rate is 15° C./minute or greater, which facilitates more efficient exfoliation of the hexagonal boron nitride layers. In another preferred embodiment, the heating rate is 50° C./minute or greater, which results in even more dramatic expansion of the material and formation of the expanded structure.

The thermal shocking process causes the guest molecules trapped between the layers of hexagonal boron nitride to rapidly volatilize, creating internal pressure that forces the layers apart.

This rapid expansion results in the formation of a separated flakey surfaces with significantly increased surface area and reduced density compared to the original hexagonal boron nitride material.

The resulting expanded hexagonal boron nitride exhibits a highly porous, three-dimensional structure with expanded layers that maintain the hexagonal crystal structure of boron nitride. This expanded structure provides enhanced properties for various applications, including improved thermal conductivity, increased surface area for adsorption applications, and enhanced performance as a catalyst support material.

The expanded hexagonal boron nitride may be formed into thin sheets by any suitable method known in the art such as the methods for making thin sheets of vermiform graphite.

In another aspect, the present invention relates to expanded hexagonal boron nitride formed by the method disclosed herein.

In one embodiment, an expanded state of hexagonal boron nitride (h-BN) was intercalated with guest molecules and then a rapid thermal shock was applied. Three acids—nitric, sulfuric, and phosphoric—were used as intercalants, and the experiments were conducted with SP6 and SP30 h-BN (D₅₀=6 microns and 30 microns, respectively). The furnace temperatures varied during the thermal shock. X-ray Diffraction (XRD) confirmed successful intercalation of h-BN with phosphoric and sulfuric acids, while nitric acid intercalation was unsuccessful under the same conditions. Following thermal shock, XRD and Scanning Electron Microscopy (SEM) results indicated potential changes in the h-BN crystallography when intercalated with phosphoric acid. The process also produced boron phosphate, which production can be minimized by modification of the thermal shock conditions.

The present invention employs intercalation of Bronsted acids between 2D nanosheets to create expanded h-BN². Subjecting h-BN to a sharp thermal shock in this state induces the desired expansion resulting in the desired layered crystal structure with hexagonally arranged atoms.

### Examples

Three acids were tested with two different h-BN sizes (SP 6 and SP 30): nitric acid (70%), sulfuric acid (96%), and phosphoric acid (80%). These acids were selected based on their usability, safety, boiling points, and prior success reported in literature. The acids were mixed with h-BN and stirred using a glass rod. To achieve an optimal ratio, 70-200 mg of h-BN was combined with 0.5-1 mL of acid. After thorough mixing, the solution was allowed to settle, excess acid was decanted, and the solution was drop-cast onto glass slides with a pipette to ensure a thin film for efficient drying. Drying was carried out in an oven set to 130° C. with a slight vacuum to remove excess vapor. Drying times varied from a week to several months, with initial drying on a hot plate also explored as an alternative method.

Changes in color, consistency, and the extent of drying were observed before proceeding to characterization. X-ray diffraction (XRD) was employed to assess successful intercalation by detecting a 001n peak around 13° (2Θ). The results for SP6 and SP30 h-BN are summarized in Tables 1 and 2, respectively.

TABLE 1
Summary of post-drying results for
SP6 h-BN with various intercalants.

| | | Consistency | |
|---|---|---|---|
| SP 6 h-BN w/: | Color Change | Change | 001n XRD Peak |
| Nitric Acid | X | X | X |
| Sulfuric Acid | ✓ | ✓ | ✓ |
| Phosphoric Acid | ✓ | ✓ | ✓ |

TABLE 2
Summary of post-drying results for SP30
h-BN with various intercalants.

| | | Consistency | |
|---|---|---|---|
| SP 30 h-BN w/: | Color Change | Change | 001n XRD Peak |
| Nitric Acid | X | X | X |
| Sulfuric Acid | ✓ | ✓ | X |
| Phosphoric Acid | ✓ | ✓ | ✓ |

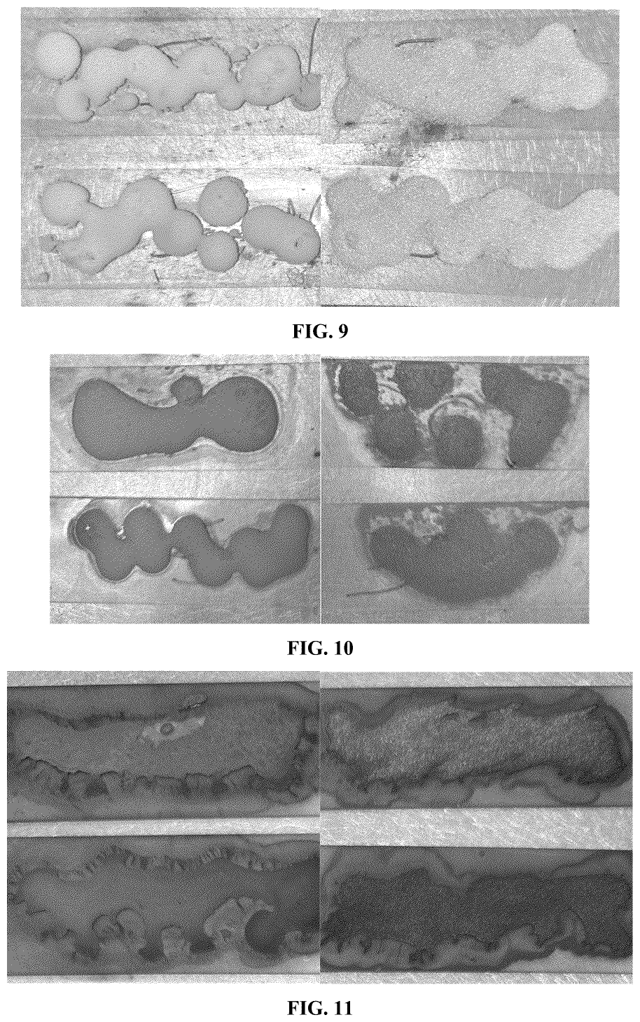

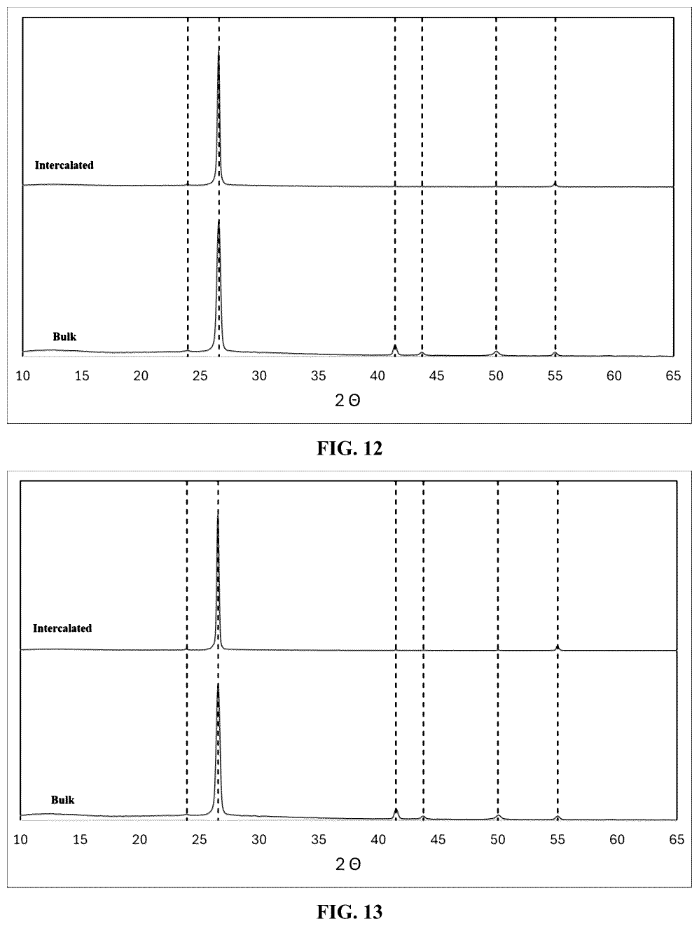

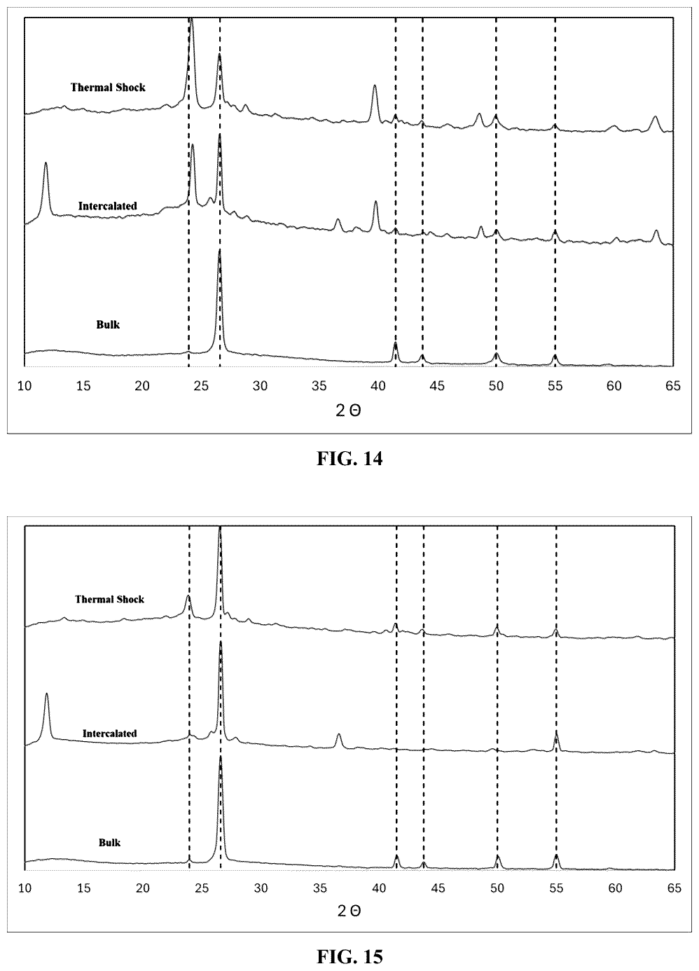

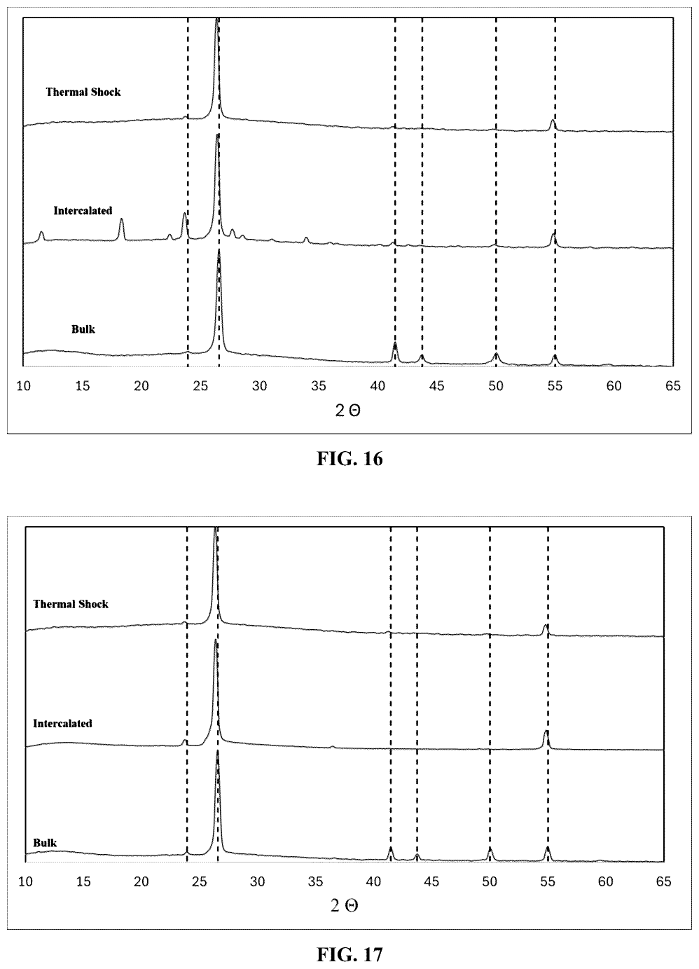

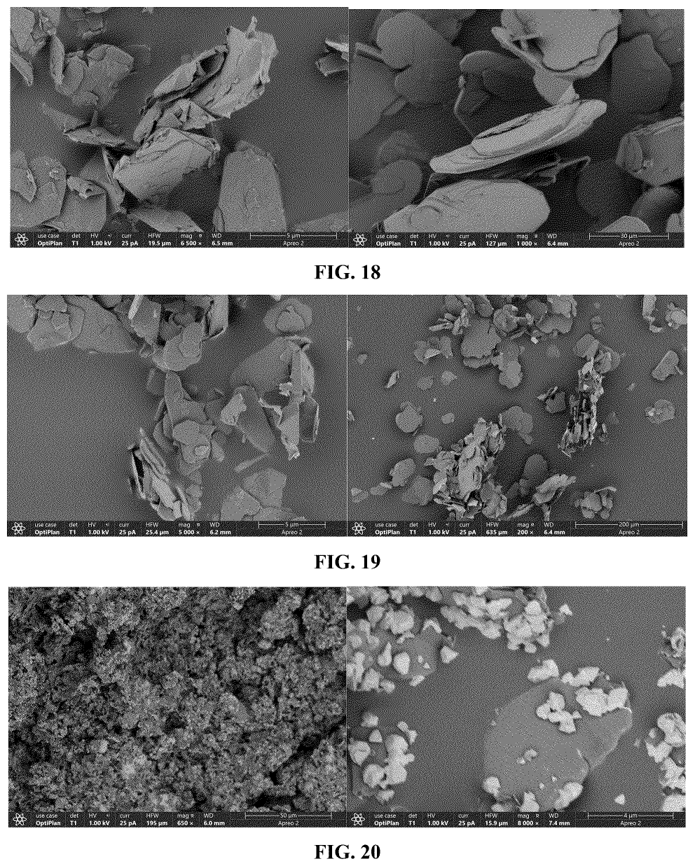

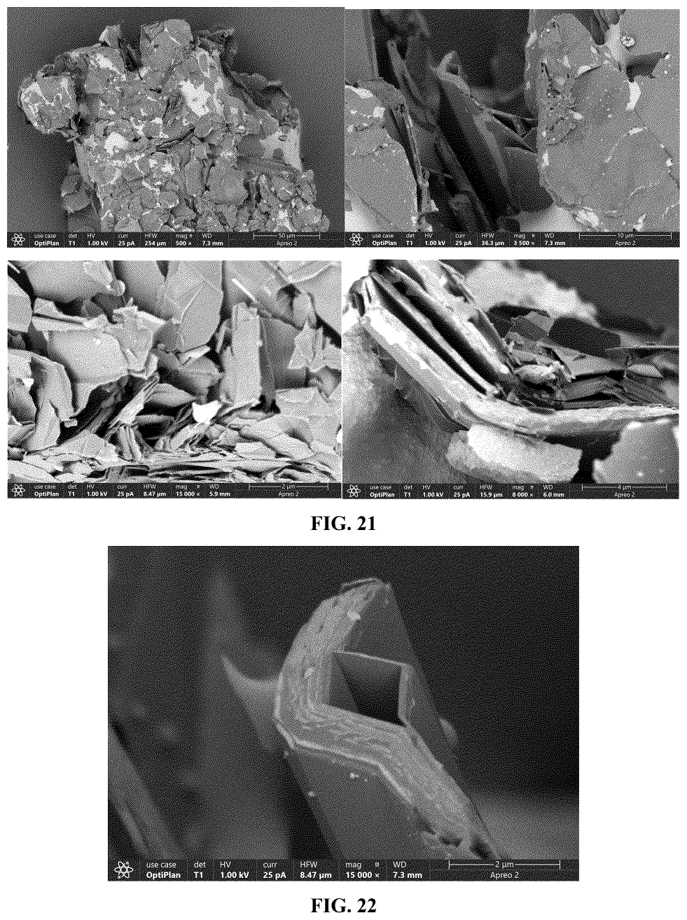

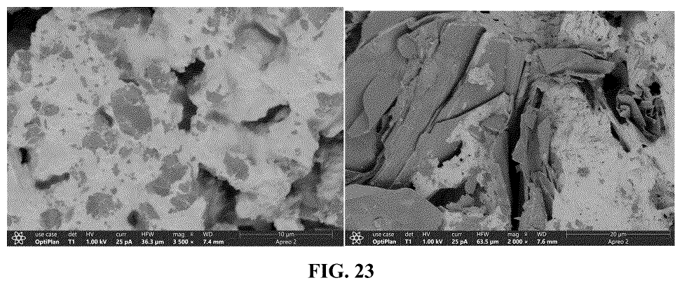

The nitric acid samples dried significantly faster in the oven, often within a couple of days, likely due to its lower boiling point. However, the dried powder closely resembled the bulk material, being pure white and retaining a loose consistency, which suggested unsuccessful intercalation. (FIG. 9)

Phosphoric acid samples dried within the expected 7-10 day timeframe. The resultant material exhibited a noticeable gray color and a clay-like consistency, indicating successful intercalation as shown in FIG. 10.

Sulfuric acid samples required extended drying times, sometimes up to several months in the oven. To address this, a hot plate was used prior to transferring to the oven, which improved the drying process and resulted in adequately dried samples with a color change similar to those from phosphoric acid as shown in FIG. 11.

XRD analysis showed that SP6 h-BN intercalated with sulfuric and phosphoric acids exhibited changes from the bulk phase and displayed the 001n peak, indicating successful intercalation. SP30 h-BN showed successful intercalation only with phosphoric acid. The smaller size of SP6 h-BN likely facilitated easier intercalation, while sulfuric acid posed challenges with drying.

Additionally, XRD spectra for phosphoric and sulfuric acid samples revealed an increased intensity of a peak at 24°, which is present in bulk h-BN but significantly more pronounced in SP6 samples post-intercalation. The nitric acid samples showed no change in spectra from the bulk phase, as seen in FIG. 13.

### Thermal Shock

The nitric acid samples showed no signs of intercalation, so thermal shock experiments were conducted only with the phosphoric and sulfuric acid samples. These experiments began at 900° C., since this high temperature would more effectively vaporize any intercalated particles and enhance the likelihood of successful expansion. Scanning Electron Microscopy (SEM) and X-ray Diffraction (XRD) were employed to evaluate changes in the h-BN structure. The results are summarized in Tables 3 and 4.

TABLE 3
Summary of thermal shock results for
SP6 h-BN with various intercalants.

| SP 6 h-BN Intercalated w/ | SEM Evidence | XRD Spectra Changes |
|---|---|---|
| Sulfuric Acid | X | X |
| Phosphoric Acid | X | ✓ |

TABLE 4
Summary of thermal shock results for
SP30 h-BN with various intercalants.

| SP 30 h-BN Intercalated w/ | SEM Evidence | XRD Spectra Changes |
|---|---|---|
| Sulfuric Acid | X | X |
| Phosphoric Acid | ✓ | ✓ |

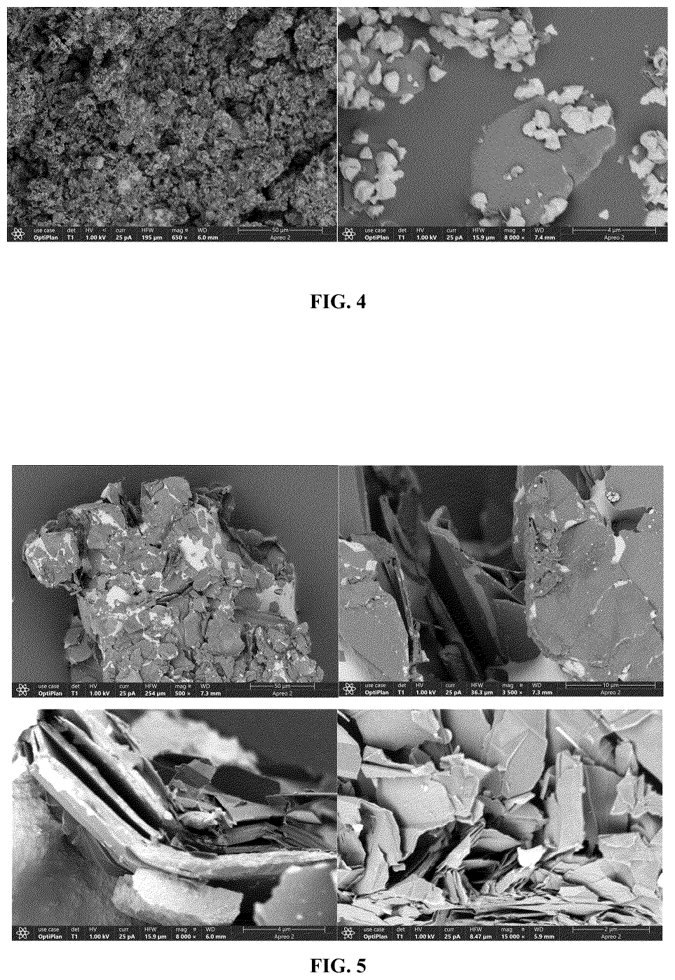

Among the samples, only the phosphoric acid samples demonstrated evidence of expansion. This result is likely due to difficulties encountered with sulfuric acid intercalation. This observation was further confirmed by a secondary XRD analysis, which showed that the intercalation peak could disappear after extended drying. SEM images of the phosphoric acid samples, as shown in FIGS. 4 and 5, revealed the formation of a secondary material. This material appeared both crystalline and amorphous. The crystalline phase was predominantly present in the SP6 samples, while the amorphous phase acted as a binder in both sample types. Further analysis suggested that the crystalline material closely resembled boron phosphate, which was also supported by the XRD spectra showing good agreement with boron phosphate. The observed difference in phase may be attributed to the smaller surface area and more efficient intercalation of the SP6 h-BN, leading to more reaction with phosphoric acid and prolonged exposure to heat. Conversely, performing the expansion at 500° C. did not result in the formation of crystalline material, only the amorphous phase.

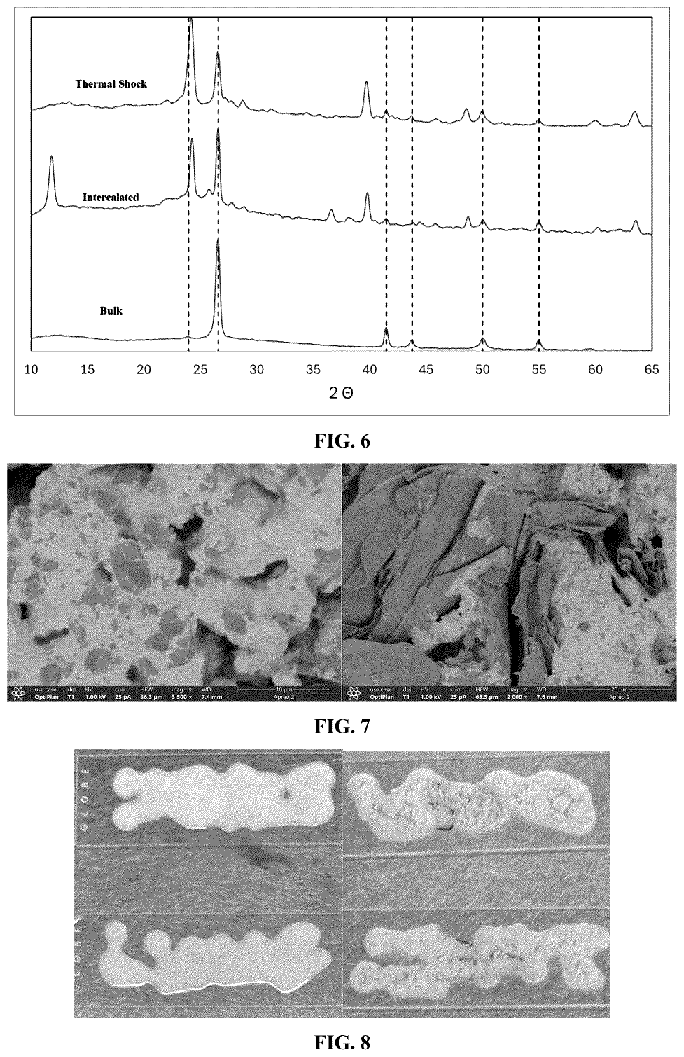

Despite the presence of boron phosphate, the XRD spectra still indicate changes in the crystallography of the phosphoric acid samples. Compared to bulk h-BN, several new peaks appeared at the lower end of the spectrum, as seen in FIG. 6. The peak at 24 degrees, formed during the intercalation phase, was retained in both the SP6 and SP30 samples. Additionally, several smaller peaks at even lower angles suggest potential expansion.

SEM images reveal gaps and disorder within the layered structure, particularly in the SP30 h-BN samples as seen in FIG. 5. However, due to the concentration of boron phosphate in the SP6 samples, visual evidence was limited as seen in FIG. 4.

Preliminary studies were conducted to assess how temperature affects the expansion process. Specifically, expansion of the phosphoric acid samples was tested at 500° C. to try to reduce the production of boron phosphate. Contrary to expectations, SEM images (see FIG. 7) showed no reduction in boron phosphate.

### CONCLUSION

Intercalation of both SP6 and SP30 h-BN was successfully achieved using phosphoric acid and sulfuric acid. Nitric acid, however, did not produce successful intercalation. Phosphoric acid demonstrated superior efficiency in intercalating between the boron nitride nanosheets compared to sulfuric acid, as evidenced by a more pronounced 001n peak in the XRD spectra. Additionally, SP6 was more easily intercalated than SP30 h-BN due to its smaller lateral area. As a result of the more effective intercalation, only the phosphoric acid samples exhibited changes after thermal shock. SEM images indicate alterations in the layer spacing of SP30 h-BN. Boron phosphate formation was also observed in the process.

### REFERENCES

[1]D. Chung. Flexible graphite for gasketing, adsorption, electromagnetic interference shielding, vibration damping, electrochemical applications, and stress sensing. Journal of Materials Engineering and Performance, 9:161-163, April 2000.
[2]D. Lee et al. Scalable exfoliation process for highly soluble boron nitride nanoplatelets by hydroxide-assisted ball milling. Nano Letters, 15(2):1238-1244, January 2015.

What is claimed is:

1. A method for making expanded hexagonal boron nitride comprising steps of:
intercalating hexagonal boron nitride with one or more guest molecules to form an intercalated hexagonal boron nitride; and
thermally shocking the intercalated hexagonal boron nitride to form expanded hexagonal boron nitride.

2. The method of claim 1, wherein the one or more guest molecules are strong acids.

3. The method of claim 2, wherein the strong acid is selected from the group consisting of sulfuric acid, phosphoric acid, perchloric acid, chloric acid, hydrobromic acid, hydrochloric acid, hydroiodic acid, acetic acid, formic acid, benzenesulfonic acid, and water.

4. The method of claim 1, wherein the step of thermally shocking the intercalated hexagonal boron nitride is carried out at a temperature of from about 300° C. to about 1000° C.

5. The method of claim 1, wherein the hexagonal boron nitride has an average particle size of from about 1 micron to about 50 microns.

6. The method of claim 1, wherein the hexagonal boron nitride is intercalated with the one or more guest molecules in a mass ratio of 0.1 to 100 grams of the one or more guest molecules per gram of hexagonal boron nitride.

7. The method of claim 1, wherein the step of thermally shocking the intercalated hexagonal boron nitride is carried out at a temperature of from about 500° C. to about 1000° C.

8. The method of claim 1, wherein the step of thermally shocking the intercalated hexagonal boron nitride is carried out at a heating rate of 10° C./minute or greater.

9. The method of claim 1, wherein the step of thermally shocking the intercalated hexagonal boron nitride is carried out at a heating rate of 15° C./minute or greater.

10. The method of claim 1, wherein the step of thermally shocking the intercalated hexagonal boron nitride is carried out at a heating rate of 50° C./minute or greater.

11. An expanded hexagonal boron nitride formed by the method of claim 1.

12. The expanded hexagonal boron nitride of claim 11, having an in-plane thermal conductivity of greater than 400 W/mK.

13. The expanded hexagonal boron nitride of claim 11, having an out-of-plane thermal conductivity of less than 100 W/mK.

14. The expanded hexagonal boron nitride of claim 11, wherein the expanded hexagonal boron nitride is in the form of a sheet having a thickness of from about 1 micron to about 100,000 microns.

15. The expanded hexagonal boron nitride of claim 11, wherein the expanded hexagonal boron nitride is formed using a strong acid is selected from the group consisting of sulfuric acid, phosphoric acid, perchloric acid, chloric acid, hydrobromic acid, hydrochloric acid, hydroiodic acid, acetic acid, formic acid, benzenesulfonic acid, and water.
